(19) United States
(12) Patent Application Publication
(10) Pub. No.: US 2008/0041355 A1
(43) Pub. Date: Feb. 21, 2008

(54) Process and device for prestressing of solid blocks

(76) Inventor: Yeshaya Yarnitsky, Haifa (IL)

Correspondence Address: Dr. Bernard Crammer, 10 Rehov Chisin, Tel Aviv, 64284, omitted

(21) Appl. No.: 11/499,792

(22) Filed: Aug. 7, 2006

(51) Int. Cl. B28D 1/32

(52) U.S. Cl. 125/23.01

(57) ABSTRACT

A process of controlled prestressing of a hard block by applying pressures in different directions and at different levels to allow splitting of the hard block into two clean plates and void of any markings on the plates.

### FIELD OF THE INVENTION

The invention relates generally to a method of prestressing solid blocks. In particular it relates to a process of controlled prestressing of hard blocks by means of applying pressures in different directions and at different levels to allow splitting of the said block into two clean plates and void of any markings on the plates.

### BACKGROUND OF THE INVENTION

Building blocks have been used for centuries to construct homes, office buildings, churches, and many other structures. Early building blocks were hewn from stone into appropriate shapes that were assembled together to form a wall.

Concrete blocks have been a basic building material for decades. Concrete blocks have been designed for use in many applications. One of the well known uses is splitting the concrete block to create an irregular front face or “rock face” on the block. Producing irregular or non-uniform blocks from cement is well known in the art. For example in Scherer's U.S. Pat. Nos. 7,146,974, 7,004,158 and 6,910,474 there are described methods of splitting concrete blocks to produce irregular edges on all of the edges of the concrete block front faces. It is clear that Scherer's methods teach away from the application of Prestress methods to produce clean cut blocks.

### BRIEF DESCRIPTION OF THE DRAWINGS

In the drawings:

FIG. 1 shows a schematic plane view of a stone block where 2 and 3 are metal blades placed vertically on the stone block and 4 and 5 are metal blades placed horizontally on the same stone block. The pressure A from both sides is distributed on selected faces of the stone block. The pressure B is distributed on the block parallel to the blade pair 2 and 3. The pressure E is distributed on the block parallel to blade pair 4 and 5 on both sides of the block. The pressures C and D are localized on the blade pairs 2 and 3, 4 and 5 respectively.

FIG. 2 shows a schematic plane view of a stone block where 2 and 3 are the upper and lower jaw of the press. 4 and 5 are rubber pads inserted between the lower and upper jaws of the press and the stone block 1, 6 and 7 are two chisel knives above and underneath the stone block. 8 are virtual stress planes on the stone when prestressed.

### DETAILED DESCRIPTION OF THE INVENTION

Controlled prestressing of a hard block by means of pressures applied in different directions and at different levels allowing the block to split cleanly into two plates suitable as facing material for buildings and sidewalk walls. Preferably the hard block is selected from natural or synthetic stone, granite, marble, dolomite, chalk rock, concrete, basalt and any other suitable hard material. The appearance of the natural block used is preserved. A further advantage of the controlled prestressing method is that there are no marks or signs on the produced hard plates.

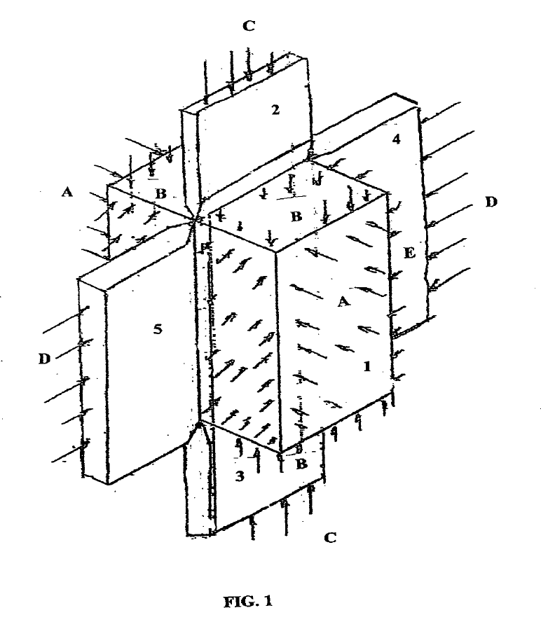

The hard block such as, for example, a stone block undergoes two types of pressure. The first is distributed pressure on the stone block faces from opposite side as shown in the figure A, B and E. The second are localized pressures through the metallic blades C, D as shown in FIG. 1.

The splitting effect is initiated by subjecting the stone block to controlled distributed pressure on selected faces, followed by application to one or two pairs of opposed blades, driven by localized pressure, at the edges of the intended split plane. Under this impact the block neatly and cleanly cracks evenly into two plates. The blades used do not penetrate the stone and only the contact marks remain.

FIG. 1 shows a stone block wherein the penetrating setup provides distributed pressure for application to selected faces of the stone block.

The stone block can be obtained by various known methods such as sawing on all side and to take into consideration its dimensions sufficient for splitting into two plates. Different materials besides stone may be used for the blocks such as, for example, chalk rock, dolomite, marble, granite, basalt, natural or synthetic stone or other hard minerals suitable for wall facing and similar building objects. The stone blocks can range in size from several hundreds of square centimeters to several square meters and thickness from at least 4 cm. Preferably the thickness of the stone block is from 1 to 100 cm. More preferably the thickness of the stone block is from 4 to 10 cm.

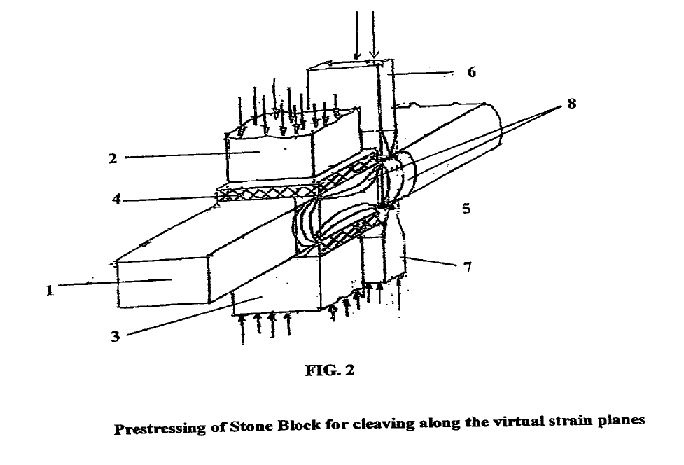

The pressure is applied on the block by means of rubber pads [4] and [5] which are inserted between the upper and lower jaws of the press [2] and [3] and the block [1] as shown in FIG. 2. The rubber pads allow equal pressure on the faces of the block. It is not necessary for the block to be completely flat. Two chisel knives [6] and [7] are attached to the two jaws of the press, a short distance from the upper and lower faces of the rubber pads. When the rubber pads are squeezed by slowly increasing the pressure, the two chisel knives come into contact with the block. On increasing the pressure the rubber pads are further squeezed and the pressure on the chisel knives on the block causes uniform cleavage of the solid block along virtual straight planes. The higher the pressure applied on the block the cleaner are the virtual planes of stress. Virtual stress planes [8] on the block are shown in FIG. 2

By changing the positions and directions of the rubber pads on the block allows different strains on the block to cause uniform cleavages on the block to obtain plates.

The source of pressure that is applied to the block is obtained from an external power supply which will prestress the block in the chosen direction. The pressure source is synchronized with the chisel-knife operation.

The prestressing of the stone block can be applied to all the faces or some of the faces of the block. The localized pressures C and D, or C or D, as shown in the drawing of the metallic blade pairs can be provided externally by mechanical or a hydraulic press. The pressures can be adjusted constant, uniform or variable and controlled in any direction and at all required levels. The pressures at A, B and E in the drawing are transmitted through elastic cushions of different elasticity. Preferably the cushions comprise compressing layers of different elasticity. The cushions can be of any suitable material such as, for example, rubber or any rubber derivative, wood or any wood product, granular material selected from sand, glass, plastic, metals and similar material suitable for the cushions to enable the cushions to transmit the pressures to stone blocks.

One or both blade pairs can be applied in their respective directions either simultaneously or successively to the stone block. One blade pair can be applied below the fracture level of the block and the second blade pair can be applied to induce the split of the block. The blades can be made of different hard materials such as carbon or alloyed steels, tungsten carbide, titanium and other suitable hard materials. The blades can consist of either one piece to span the whole block or joined segments. The blades can be plane or curved in design with one or more beveled edges with provision for rotation so that a new beveled edge blade can be substituted for a damaged or blunted one. The beveled blade-edge angle can be acute or obtuse. The blades are vertical to the block with the block prestressed in any direction.

The foregoing disclosure has been set forth to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A process of controlled prestressing of a block by means of applying pressures in different directions and at different levels to allow splitting of the block into two clean plates without the need of manual or mechanical methods and void of any markings on the plate.

2. A process of controlled prestressing of a block by means of applying pressures in different directions and at different levels to allow splitting of the block into two clean plate's void of any markings on the plates comprising:
a press wherein rubber pads are inserted between the upper and lower jaws of the press and the block and two chisel knives are attached to the two jaws of the said press and on applying pressure the chisel knives come into contact with the block causing uniform cleavage of the solid block along virtual straight plane.

3. A process according to claim 1, wherein the block is made of a suitable hard material.

4. A process of claims 1 and 2 wherein the block is selected from stone, chalk rock, dolomite, concrete, marble, granite and basalt.

5. A process of claim 3 wherein the stone is natural or synthetic.

6. A process of claim 1 where the block size ranges from several hundreds of square centimeters to several square meters.

7. A process of claim 5 where the block thickness is in the range of 1 to 100 cms.

8. A process of claim 6 where the block thickness is in the range of 4 to 10 cms.

9. A process according to claim 1 where the pressure applied to the block faces is provided by hydraulic, pneumatic or mechanical methods.

10. A pair of uniform plates obtained by the process of claim 1.
